(19) United States
(12) Patent Application Publication
(10) Pub. No.: US 2020/0240047 A1
(43) Pub. Date: Jul. 30, 2020

(54) METHOD AND SYSTEM FOR PRODUCING UNIDIRCTIONAL CARBON FIBER TAPE AS WELL AS METHOD FOR SURFACE TREATING CARBON FIBERS

(71) Applicant: SABIC GLOBAL TECHNOLOGIES B.V., Bergen op Zoom (NL)

(72) Inventors: Kapil Inamdar, Exton, PA (US); Jan Henk Kamps, Bergen op Zoom (NL); Ruud Van Der Heijden, Bergen op Zoom (NL); Nikhil Verghese, Geleen (NL); Teena Bonizzi, Geleen (NL); Luke Henderson, Waurn Ponds (AU); Christina Scheffler, Dresden (DE)

(21) Appl. No.: 16/635,612

(22) PCT Filed: Aug. 1, 2018
(86) PCT No.: PCT/IB2018/055796

§ 371 Date: Jan. 31, 2020

Related U.S. Application Data
(60) Provisional application No. 62/539,857, filed on Aug. 1, 2017.
(60) Provisional application No. 62/539,879, filed on Aug. 1, 2017.

(51) Int. Cl. D01F 9/22; B29B 15/10; B29B 15/12; B29C 70/20; C08J 5/04; C08J 5/06; D01F 11/12; D01F 11/14

(52) U.S. Cl. CPC D01F 9/22; B29B 15/105; B29B 15/122; B29C 70/20; B29K 2307/04; C08J 5/06; D01F 11/12; D01F 11/14; C08J 5/042

(57) ABSTRACT

The method for producing a unidirectional carbon fiber tape, the method comprising: passing a first portion of a strand of fiber through an oven to carbonize the first portion, thereby converting carbon fiber precursor fiber of the first portion to carbon fiber, wherein the first portion comprises carbon fiber precursor fiber; and impregnating the carbon fiber of the first portion with thermoplastic matrix material to form impregnated fiber, while a second portion of the strand of fiber that is upstream of the first portion is passing through the oven to convert carbon fiber precursor fiber of the second portion to additional carbon fiber.

### CROSS REFERENCE TO RELATED APPLICATIONS

This application claims priority to U.S. Provisional Application Ser. No. 62/539,857, filed Aug. 1, 2017, and to U.S. Provisional Application Ser. No. 62/539,879, filed Aug. 1, 2017, both of which are incorporated herein in their entirety.

### BACKGROUND

### Field of Invention

Disclosed herein are methods of producing carbon fibers, as well as the fibers so produced and the systems therefore. Especially disclosed are integrated production and impregnation, as well as electrolytic treatment.

### Description of Related Art

Composite laminates can be used to form structures having advantageous structural characteristics, such as high strengths, high stiffnesses, and/or the like, as well as relatively low weights when compared to similar structures formed from conventional materials. As a result, composite laminates are used in a variety of applications across a wide range of industries, including the automotive, aerospace, and consumer electronics industries.

Typically, to produce a laminate, such as a unidirectional fiber tape, one or more strands of fibers, fibers of each of which are twisted and/or held together by sizing in a bundle, are each unwound from a respective spool, and the one or more strands are subsequently spread to produce a spread fiber layer. The spread fiber layer is then impregnated with a matrix material.

If impregnation of the spread fiber layer is insufficient, the laminate can suffer from unpredictable and/or undesirable characteristics, such as an unpredictable and/or variable fiber volume fraction, an unpredictable and/or uneven density, poor fiber-matrix material interface resulting in reduced load transfer/handling capability, premature part failure in application, and/or the like. The risk of such insufficient impregnation may be heightened when the fibers are not sufficiently juxtaposed during spreading of the one or more strands, when the spread fiber layer has a low permeability (e.g., as in a spread fiber layer of carbon fibers), when using a thermoplastic matrix material (e.g., due to the low melt strengths, high viscosities, and/or high processing temperatures associated with such materials), and/or depending on the impregnation technique being used, such as, but not limited to, a melt-based impregnation technique.

Furthermore, structural characteristics of a laminate can depend heavily on interfacial properties of the fibers and the matrix material, such as wettability and adhesion. For example, poor wettability can cause insufficient impregnation of the fibers with the matrix material during production of the laminate, resulting in unpredictable and/or undesirable characteristics in the laminate, such as an unpredictable and/or uneven density. For further example, poor adhesion can reduce the strength and/or stiffness of the laminate by, for example, encouraging debonding between the fibers and the polymeric matrix material.

### SUMMARY

Disclosed herein are methods for making carbon fibers, and systems therefore.

A method for producing a unidirectional carbon fiber tape, the method comprising: passing a first portion of a strand of fibers through an oven to carbonize the first portion, thereby converting carbon fiber precursor fibers of the first portion to carbon fibers, wherein the first portion comprises carbon fiber precursor fibers; and impregnating the carbon fibers of the first portion with thermoplastic matrix material to form impregnated fibers, while a second portion of the strand of fibers that is upstream of the first portion is passing through the oven to convert carbon fiber precursor fibers of the second portion to additional carbon fibers.

A method for surface treating carbon fibers, the method comprising: immersing the carbon fibers in a bath containing an electrolytic solution, the electrolytic solution having a conductivity; and applying a voltage and a current to the electrolytic solution, wherein the value of the applied voltage in volts (V) and the value of the applied current in amps (A) are within 10% of a voltage value and a current value, respectively, that satisfy the following relationship:

τ=−0.32VI+0.24VC+2.1856V+2.4512I−2.4084C+48.7663,

where τ is the value of the interfacial shear strength in Newtons per square millimeter (N/mm²) between the carbon fibers and the matrix material (preferably the polycarbonate matrix material), V is the voltage value, I is the current value, and C is the value of the conductivity in millisiemens per centimeter (mS/cm).

A system for producing a unidirectional carbon fiber tape, the system comprising: an oven configured to receive and carbonize a portion of a strand of carbon fiber precursor fibers, thereby converting carbon fiber precursor fibers of the portion to carbon fibers; an impregnation unit configured to receive the portion of the strand from the oven and to impregnate carbon fibers of the portion with molten thermoplastic matrix material; and a guiding element configured to direct the portion of the strand from the oven to the impregnation unit.

Some details associated with the embodiments are described above, and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a flow chart depicting some of the present methods for integrating production of carbon fibers and impregnation of those fibers with a matrix material, which include: (1) converting precursor fibers to carbon fibers; (2) in some instances, electrolytically surface treating those carbon fibers; and (3) impregnating those carbon fibers with matrix material.

FIG. 2 is a schematic of one of the present systems that can be used to perform at least some of the methods of FIG. 1, the system including one or more ovens for converting carbon fiber precursor fibers to carbon fibers, a bath containing an electrolytic solution for electrolytically surface treating those carbon fibers, and an extruder for impregnating those carbon fibers with matrix material.

FIG. 3 is a schematic of an impregnation unit that may be suitable for use with some embodiments of the present methods and/or systems.

FIG. 4 is a flow chart depicting some of the present methods for electrolytically surface treating carbon fibers, which can be used in some of the methods of FIG. 1 or independently of the methods of FIG. 1.

FIGS. 5A-5D are each a graph of predicted interfacial shear strength between a polycarbonate matrix material and carbon fibers that have been surface treated in a bath containing an electrolytic solution, showing the predicted interfacial shear strength as a function of voltage and current applied to the electrolytic solution and at a respective conductivity of the electrolytic solution.

FIG. 6 is a graph showing surface polarity and atomic concentration of certain surface groups of carbon fibers, those of which that are labeled 2-7 having been surface treated in a bath containing an electrolytic solution at various voltages and currents applied to the electrolytic solution and at various conductivities of the electrolytic solution. Carbon fibers labeled 1 were not electrolytically surface treated.

FIG. 7 is a graph showing actual versus predicted interfacial shear strengths between carbon fibers, some of which have been electrolytically surface treated, and a polycarbonate matrix material.

FIG. 8 is a graph showing the effect of sizing on interfacial shear strengths between electrolytically surface treated carbon fibers and a polycarbonate matrix material.

FIG. 9A is a scanning electron microscope (SEM) image of carbon fibers that have not been electrolytically surface treated.

FIGS. 9B-9G are SEM images of carbon fibers that have been electrolytically surface treated.

### DETAILED DESCRIPTION

Disclosed herein are producing carbon fibers. For example, methods and systems for integrating production of carbon fibers and impregnation of those fibers with matrix material, and methods for electrolytic surface treatment of carbon fibers. For example, in some methods, at upstream portion(s) of one or more strands of fibers, carbon fiber precursor fibers of the strand(s) are converted to carbon fibers, while, at downstream portion(s) of the strand(s), such carbon fibers are impregnated with matrix material. Such integration can reduce the need for spreading the carbon fibers, reduce or eliminate the need for sizing the carbon fibers, and/or enhance impregnation of the carbon fibers with matrix material. Methods in which the carbon fibers are immersed in a bath containing an electrolytic solution, where a voltage and/or a current applied to the electrolytic solution and/or a conductivity of the electrolytic solution are selected, in some instances, according to a predictive relationship, to achieve substantially the selected (e.g., desired) and/or a high adhesion between the carbon fibers and a polymeric matrix material.

Without being limited to the use of thermoplastic matrix materials, some embodiments of the present methods may be used to produce carbon fibers and sufficiently impregnate those carbon fibers with thermoplastic matrix material, in some instances, using a melt-based impregnation technique, despite challenges to such sufficient impregnation posed by such thermoplastic matrix materials due to their low melt strengths, high viscosities, and/or high processing temperatures. In some instances, such sufficient impregnation may be achieved with minimal spreading and/or without sizing the carbon fibers.

Some embodiments of the present methods integrate production of carbon fibers and impregnation of those fibers with matrix material. For example, some methods include carbonizing a first portion of a strand of fibers, the first portion comprising carbon fiber precursor fibers, thereby converting those carbon precursor fibers to carbon fibers, and impregnating carbon fibers of the first portion with matrix material while a second portion of the strand that is upstream of the first portion, the second portion comprising carbon fiber precursor fibers, is carbonized.

Some such methods can reduce the need for spreading the carbon fibers; for example, once produced, the carbon fibers need not be twisted and/or held together by sizing in a bundle, and, prior to impregnation, the carbon fibers need not be spread from such a bundle. In this way, impregnation of the carbon fibers with matrix material can be enhanced, costs associated with production of laminates from the carbon fibers can be reduced (e.g., by reducing the need for spreading equipment), and/or the like.

Prior to impregnation with a polymeric matrix material, carbon fibers can be electrolytically surface treated by passing the fibers through a bath containing a current-carrying electrolytic solution. Without wishing to be bound by theory, such electrolytic surface treatment can increase surface polarities of the fibers via oxidation, thereby tuning interfacial properties of the fibers and the matrix material. There are a variety of parameters associated with such electrolytic surface treatment, such as a voltage applied to the electrolytic solution, a current applied to the electrolytic solution, and a conductivity of the electrolytic solution, which may be adjusted to change such interfacial properties. However, due to the complex relationships amongst these parameters and between these parameters and such interfacial properties, varying one or more of these parameters may not have a recognized and/or predictable effect on such interfacial properties.

Some embodiments of the present methods can be used to achieve a desired adhesion, e.g., the highest adhesion or a reduced adhesion, etc., chosen based upon a particular application parameters and requirements. For example, an interfacial shear strength that is greater than 49.1, e.g., greater than 52.0, or greater than 60.0 Newtons per square millimeter (N/mm²)) between carbon fibers and a polymeric matrix material can be attained. For example, a desired adhesion can be attained by passing the fibers through a bath containing an electrolytic solution, where a voltage and/or a current applied to the electrolytic solution and/or a conductivity of the electrolytic solution, according to a predictive relationship (e.g., based upon the formulas discussed below).

Some such methods can be used to achieve an adhesion between the fibers and the matrix material that is sufficient to reduce or eliminate the need for sizing the fibers, thereby reducing costs associated with production of laminates from the fibers.

Sizing is often applied to fibers to mitigate the risk of damage to the fibers during handling, such as, for example, during bundling, spreading, spooling, unspooling, transportation, and/or the like of the fibers. Some such methods, by reducing such handling of the carbon fibers prior to impregnation of the carbon fibers with matrix material, can reduce or eliminate the need for sizing the carbon fibers, which can reduce costs associated with production of laminates from the carbon fibers.

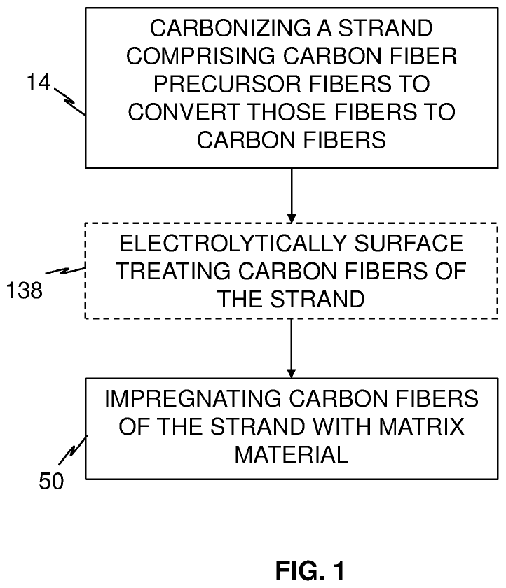

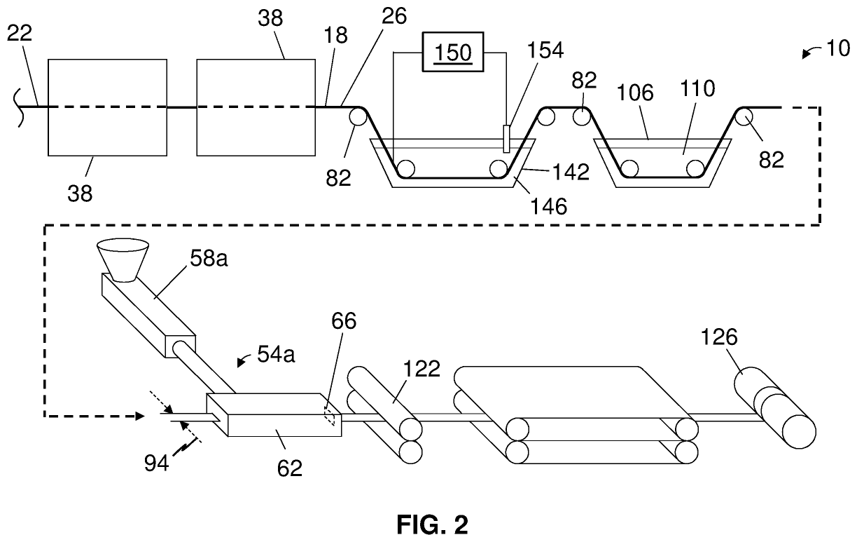

FIG. 1 depicts some of the present methods for integrating production of carbon fibers and impregnation of those fibers with a matrix material, and FIG. 2 depicts an embodiment 10 of the present systems that can be used to perform at least some of the methods of FIG. 1. Throughout this disclosure, system 10 is referenced to illustrate at least some of the methods of FIG. 1; however, system 10 is not limiting on the methods of FIG. 1, which can be performed using any suitable system.

Some of the present methods comprise a step 14 of carbonizing a strand (e.g., 18) comprising carbon fiber precursor fibers (e.g., 22) to convert those fibers to carbon fibers (e.g., 26). Carbon fiber precursor fibers of the strand can comprise any suitable carbon fiber precursor material, such as, for example, a carbonizable organic material (e.g., polyacrylonitrile (PAN), a pitch-based material, rayon, and/or the like). The carbon fiber precursor material can be provided as fibers by spinning the carbon fiber precursor material, which is a process in which the carbon fiber precursor material, in a molten state or dissolved in a solvent, is extruded through small holes in a spinneret. The strand can comprise any suitable number of fibers, such as, for example, between 250 and 610,000 fibers (e.g., a 1K, 3K, 6K, 12K, 24K, 50K, or larger strand can be used).

In some methods, carbon fiber precursor fibers (e.g., 22) are fibers comprising a carbon fiber precursor material that has been oxidized. Such oxidation can include, for example, passing the fibers through a heated, oxygen (O₂)-containing (e.g., air-containing) environment; to illustrate, the fibers can be passed through one or more oxygen-containing ovens. As used herein, an “oven” is a structure including a chamber as well as one or more heat sources (e.g., heating element(s), burner(s), and/or the like) for heating an environment within that chamber. During such oxidation, a temperature of the fibers and/or of the oxygen-containing environment can be any suitable temperature, such as one that is from 150 to 300° C., and the fibers can be heated within the oxygen-containing environment for any suitable period of time, such as one that is from 30 to 420 minutes (min).

To carbonize carbon fiber precursor fibers (e.g., 22) of the strand, the carbon fiber precursor fibers can be passed through a heated, inert environment. Such an inert environment should contain little to no oxygen (O₂) and may be filled or substantially filled with an inert gas, such as, for example, nitrogen (N₂), argon, and/or the like. During such carbonization, a temperature of the fibers and/or of the inert environment can be any suitable temperature, such as one that is from 400 to 1,800° C. In some methods, carbonization of carbon fiber precursor fibers (e.g., 22) can be performed in stages; for example, the fibers can be passed through a first inert environment having a first temperature before being passed through a second inert environment having a second temperature that is higher than the first temperature. Such staged carbonization can provide for more control over rate of temperature change of the fibers. The residence time of the carbon fiber precursor fibers within the inert environment(s) (collectively, if using more than one inert environment) can be any suitable residence time, such as one that is from 1 to 75 min, which can be selected depending on, for example, temperature within the inert environment(s).

To illustrate, carbon fiber precursor fibers (e.g., 22) of the strand can be passed through one or more ovens 38, each of which can contain a heated, inert environment. During carbonization, carbon fiber precursor fibers may release waste gas, such as that comprising water vapor, ammonia, carbon monoxide, carbon dioxide, hydrogen, nitrogen, and/or the like. To facilitate removal of such waste gas from its chamber, each of oven(s) 38 can be configured such that a gas, such as an inert gas, can be passed through its chamber. For example, each of oven(s) 38 can include a gas inlet through which gas can be introduced into its chamber and a gas outlet through which gas can be removed from its chamber. Each of oven(s) 38 can include one or more seals, each configured to restrict flow of gas through an opening of the oven through which fibers can enter or exit its chamber; such seal(s) can facilitate maintenance of an inert environment within the oven.

In some methods, carbon fibers (e.g., 26) of the strand can be graphitized by passing the fibers through an inert environment that is at a higher temperature than that of the inert environment(s) of step 14; to illustrate, the fibers can be passed through one or more ovens, each of which can comprise one or more of the features described above for oven(s) 38. During such graphitization, a temperature of the fibers and/or of the inert environment can be, for example, from 1,600 to 3,000° C.

Some of the present methods comprise a step 50 of impregnating carbon fibers (e.g., 26) of the strand with matrix material. Such impregnation can comprise a melt-based impregnation technique, or one in which the fibers are impregnated with molten matrix material. To illustrate, system 10 includes an impregnation unit 54a having an extruder 58a and an injection chamber 62 that receives matrix material from the extruder. In this way, the fibers can be passed through injection chamber 62 and thereby introduced to molten matrix material. Once so introduced, the fibers can be pulled through a die 66, which can facilitate debulking, consolidation, and/or the like of the fibers and matrix material. Some impregnation units that are otherwise similar to impregnation unit 54a can include a bath—as opposed to an injection chamber—that receives matrix material from an extruder and through which the fibers can be passed to introduce the fibers to molten matrix material.

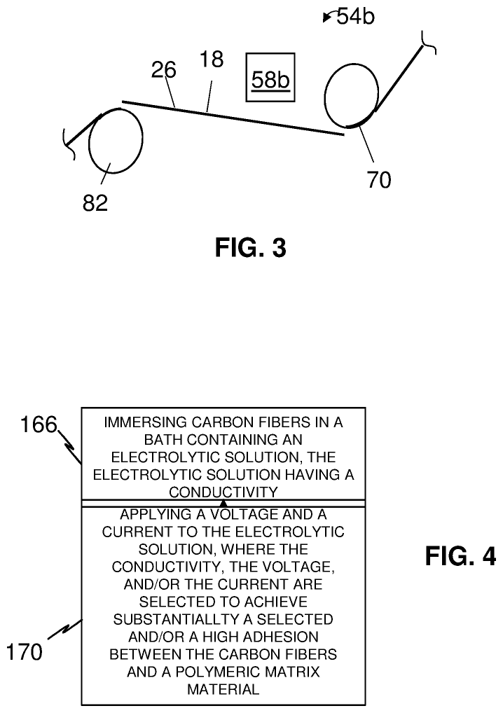

To further illustrate, FIG. 3 depicts an impregnation unit 54b including an extruder 58b that is configured to extrude a sheet of matrix material, where carbon fibers (e.g., 26) of the strand can be impregnated with molten matrix material by pressing the sheet and those fibers together. Such pressing can be accomplished, for example, by passing the sheet and the fibers together over or under and in contact with each of one or more pressing elements 70. Each of pressing element(s) 70 can comprise a roller, a pin, a plate, or the like.

While melt-based impregnation techniques may be desirable due to, for example, reduced cost and/or complexity when compared to other impregnation techniques, impregnation of carbon fibers (e.g., 26) of the strand is not limited to melt-based impregnation techniques. For example, such impregnation can be accomplished by passing the fibers through an aqueous slurry of matrix material, passing the fibers through a solution comprising matrix material dissolved in a solvent, or the like; systems for performing these impregnation techniques can include corresponding impregnation units.

The methods described with respect to FIG. 1 integrate production of carbon fibers and impregnation of those fibers with matrix material—at an upstream portion of the strand, carbon fiber precursor fibers (e.g., 22) are carbonized to produce carbon fibers (e.g., 26) while, at a downstream portion of the strand, such carbon fibers are impregnated with matrix material. To illustrate with system 10, one or more ovens 38 can receive and carbonize a portion of the strand, thereby converting carbon fiber precursor fibers (e.g., 22) of that portion to carbon fibers (e.g., 26), and the portion can then be received by impregnation unit 54a to impregnate such carbon fibers with matrix material. As shown, the portion of the strand can be directed from one or more ovens 38 to impregnation unit 54a by one or more guiding elements 82, which can comprise, for example, one or more rollers, one or more pins, one or more plates, and/or the like.

Typically, production of fibers and impregnation of those fibers with matrix material are separate processes, which are usually performed at different locations. Once carbon fibers are produced, to facilitate their storage and transportation, the fibers are generally twisted and/or held together by sizing in a bundle and wound around a spool. To produce a laminate using these fibers often requires the fibers to be unwound from the spool and spread from the bundle. At least by integrating production and impregnation of carbon fibers (e.g., 26), some methods can reduce the need for such bundling, spooling, spreading, and/or unspooling of the fibers, as well as for storage and transportation of the fibers, which, in addition to reducing costs associated with production of laminates from the fibers, can provide several advantages.

For example, impregnation of carbon fibers (e.g., 26) with matrix material can be enhanced by reducing the need for spreading of the fibers, which is a common source of challenges to effective impregnation. To illustrate, in some methods, the width (e.g., 94, FIG. 2) of a portion of the strand changes by no more than 10%, preferably, by no more than 5%, after being carbonized (and graphitized, if performed) and prior to being impregnated (e.g., after passing through one or more ovens 38 and prior to being received by impregnation unit 54a). To illustrate, the width of the portion of the strand can be any suitable width, such as, for example, one that is greater than or approximately equal to any one of, or between any two of: 20, 25, 30, 35, 40, 45, 50, 60, 70, 80, 90, 100, 125, 150, 175, 200, 250, 300, 350, 400, 450, 500, 550, or 600 mm (e.g., approximately 60, 120, or 600 mm). The width of the portion of the strand can be measured neglecting up to 5% of its lateral-most fibers.

For further example, by reducing the need for handling (e.g., bundling, spreading, spooling, unspooling, transportation, and/or the like) of carbon fibers (e.g., 26), the need for sizing the fibers—often performed to mitigate the risk of damage to fibers during handling—can be reduced or eliminated. For example, in some methods, carbon fibers (e.g., 26) are unsized prior to being impregnated with matrix material. Such unsized fibers may comprise neither a film former (e.g., polyester or polyamid, which may be applied to the fibers using an emulsion) nor a coupling agent (e.g., a silane coupling agent, an anhydride, an epoxy, and/or the like) and/or may be uncoated. Such a reduction or elimination of sizing can reduce costs associated with production of laminates from the fibers. Nevertheless, in some methods, carbon fibers (e.g., 26) of the strand can be sized prior to being impregnated with matrix material. To illustrate, the carbon fibers can be passed through a bath 106 containing a sizing material 110, which may include a film former and/or a coupling agent.

Without being limited to the use of thermoplastic matrix materials, some of the present methods may be used to produce carbon fibers (e.g., 26) and sufficiently impregnate those carbon fibers with thermoplastic matrix material, in some instances, using a melt-based impregnation technique, despite challenges to such sufficient impregnation posed by such thermoplastic matrix materials due to their low melt strengths, high viscosities, and/or high processing temperatures. Such thermoplastic matrix material can include, for example, polyethylene terephthalate (PET), polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polysulfone sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof. Thermoset matrix materials suitable for use in some of the present methods as matrix material include an unsaturated polyester resin, a polyurethane, bakelite, duroplast, urea-formaldehyde, diallyl-phthalate, epoxy resin, an epoxy vinylester, a polyimide, a cyanate ester of polycyanurate, dicyclopentadiene, a phenolic, a benzoxazine, a copolymer thereof, or a blend thereof.

Once carbon fibers (e.g., 26) of the strand are impregnated with matrix material, the carbon fibers and matrix material can optionally be consolidated to produce a laminate, such as a unidirectional carbon fiber tape. To illustrate, the impregnated carbon fibers can be pressed between calendaring rolls 122, by other pressing element(s) (e.g. roller(s), pin(s), plate(s), and/or the like), and/or the like to produce the laminate. The produced laminate can then be wound on a spool 126, cut into sections, or the like.

Some of the present methods comprise an optional step 138 of electrolytically surface treating carbon fibers (e.g., 26) of the strand prior to impregnating those fibers with matrix material (and prior to sizing those fibers, if performed). To illustrate, the fibers can be passed through a bath 142 containing an electrolytic solution 146. To apply voltage and current to electrolytic solution 146, a power source 150 can be placed in electrical communication with both the fibers and an electrode 154 that is disposed within the electrolytic solution. Power source 150 can be operated such that the fibers are an anode and electrode 154 is a cathode. Electrolytic solution 146 can comprise any suitable electrolyte, such as, for example, a salt (e.g., ammonium bicarbonate, sodium chloride, potassium nitrate, and/or the like), an acid (e.g., nitric acid, sulfuric acid, and/or the like), a base (e.g., sodium hydroxide, ammonium hydroxide, and/or the like), and/or the like. Without wishing to be bound by theory, such electrolytic surface treatment of carbon fibers (e.g., 26) can increase surface polarities of the fibers via oxidation, thereby tuning interfacial properties of the fibers and matrix material, such as wettability and adhesion. In some methods, by improving such interfacial properties, electrolytic surface treatment of carbon fibers (e.g., 26) can reduce or eliminate the need for sizing the fibers.

There are a variety of parameters associated with electrolytic surface treatment of carbon fibers, such as a voltage applied to the electrolytic solution, a current applied to the electrolytic solution, and a conductivity of the electrolytic solution. Due to the complex relationships amongst these parameters and between these parameters and their effects on the fibers, varying one or more of these parameters may not have a recognized and/or predictable effect on the fibers. As described below, some of the present methods can be used to mitigate such unpredictability.

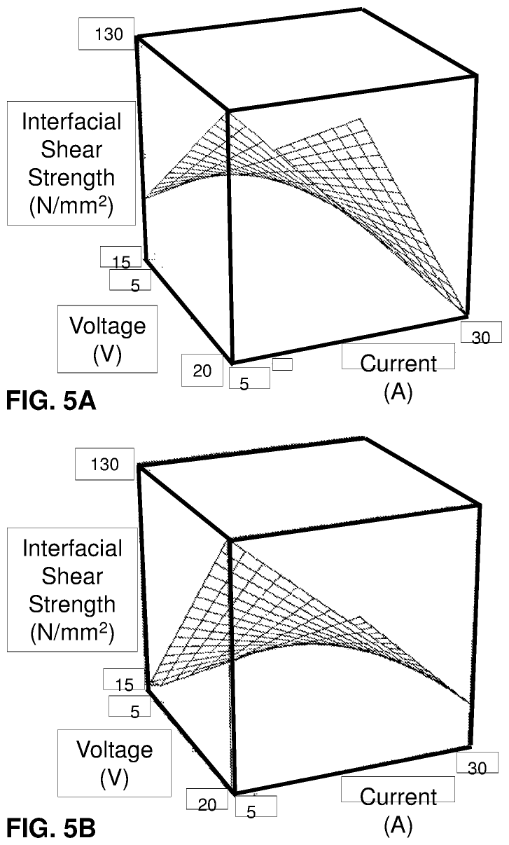

FIG. 4 depicts some of the present methods for electrolytically surface treating carbon fibers. The methods of FIG. 4 can be used in some of the methods of FIG. 1 (e.g., during step 138) or independently of the methods of FIG. 1. To illustrate, some of the present methods comprise a step 166 of immersing carbon fibers in a bath (e.g., 142) containing an electrolytic solution (e.g., 146); such fibers can, but need not, comprise carbon fibers (e.g., 26) disclosed with respect to the methods of FIG. 1.

Some of the present methods include a step 170 of applying a voltage and a current to the electrolytic solution, where the conductivity of the electrolytic solution, the voltage, and/or the current are selected to achieve substantially a selected (e.g., a desired) and/or a high adhesion between the carbon fibers and a polymeric matrix material. Such a high adhesion between the carbon fibers and the polymeric matrix material may be quantified as an interfacial shear strength between the carbon fibers and the polymeric matrix material that is greater than 49.1, greater than 52.0, or greater than 60.0 N/mm². In some of the following examples, the polymeric matrix material comprises a polycarbonate matrix material; however, the methods of FIG. 4 can be used with any suitable polymeric matrix material, including any thermoplastic matrix material or thermoset matrix material described above.

As one example, an interfacial shear strength between the carbon fibers and a polycarbonate matrix material that is greater than 52.0 N/mm² may be achieved when: (1) the conductivity is approximately 17.5 millisiemens per centimeter (mS/cm), the voltage is approximately 8 volts (V), and the current is approximately 14 amps (A); or (2) the conductivity is approximately 31.3 mS/cm, the voltage is approximately 12.5 V, and the current is approximately 26 A.

In some methods, these parameters can be selected according to a predictive relationship. For example, at least when the carbon fibers comprise PAN-based carbon fibers and the polymeric matrix material comprises a polycarbonate matrix material, the following predictive relationship can be used:

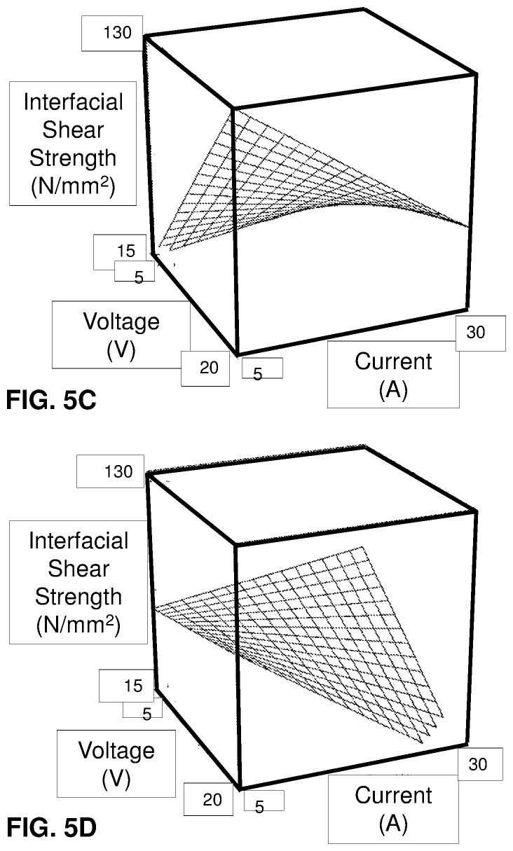

τ=−0.32VI+0.24VC+2.1856V+2.4512I−2.4084C+48.7663 (1)

where τ is the value of an interfacial shear strength of the PAN-based carbon fibers and the polycarbonate matrix material in N/mm², V is the value of a voltage applied to the electrolytic solution in V, I is the value of a current applied to the electrolytic solution in A, and C is the value of a conductivity of the electrolytic solution in mS/cm. Provided by way of illustration, FIGS. 5A-5D are each a graph of τ versus V and I, holding C constant—for FIG. 5A, C is 17; for FIG. 5B, C is 31; for FIG. 5C, C is 40; and for FIG. 5D, C is 5. In an alternate form, Eq. 1 can be expressed as:

τ=2.8V−0.32×(I−13.71)(V−7.66)−0.57C+0.24(V−7.66)(C−20.84)+44.06 (2)

For example, in some methods, this predictive relationship can be used to achieve substantially the selected (e.g., desired) adhesion between the PAN-based carbon fibers and the polycarbonate matrix material. To illustrate, an interfacial shear strength for the PAN-based carbon fibers and the polycarbonate matrix material can be selected, and a voltage and a current can be applied to the electrolytic solution such that the value of the applied voltage in V and the value of the applied current in A are within 10% (e.g., within 5%) of a voltage value (V) and a current value (I), respectively, that satisfy Eq. 1 with τ equal to the value of the selected interfacial shear strength in N/mm² and C equal to a conductivity of the electrolytic solution in mS/cm. Suitable values for a selected interfacial shear strength can be, for example, those that are between 15 and 170 N/mm² (e.g., between 30 and 60 N/mm²).

For further example, in some methods, this predictive relationship can be used to achieve a high adhesion between the PAN-based carbon fibers and the polycarbonate matrix material. To illustrate, a voltage applied to the electrolytic solution, a current applied to the electrolytic solution, and a conductivity of the electrolytic solution can be selected such that using the values of the applied voltage in V (V), the applied current in A (A), and the conductivity in mS/cm (C) in Eq. 1 returns a τ that is greater than 49.1, greater than 52.0, greater than 60.0, or other threshold value.

When using this predictive relationship, it is currently preferred that the voltage applied to the electrolytic solution be between 5 and 20 V (e.g., 5 and 15 V), the current applied to the electrolytic solution be between 5 and 30 A, and/or the conductivity of the electrolytic solution be between 5 and 40 mS/cm. Non-limiting examples of parameters that can be used with the present methods include: (1) a voltage applied to the electrolytic solution that is greater than or substantially equal to any one of, or between any two of: 5, 6, 7, 8, 9, 10, 11, 12, 13, 14, 15, 16, 17, 18, 19, or 20 V; (2) a current applied to the electrolytic solution that is greater than or substantially equal to any one of, or between any two of: 5, 6, 7, 8, 9, 10, 11, 12, 13, 14, 15, 16, 17, 18, 19, 20, 21, 22, 23, 24, 25, 26, 27, 28, 29, or 30 A; and (3) a conductivity of the electrolytic solution that is greater than or substantially equal to any one of, or between any two of: 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mS/cm.

The predictive relationship expressed in Eq. 1 is particularly suited for use in connection with PAN-based carbon fibers and polycarbonate matrix materials; however, this predictive relationship may be used in connection with other types of carbon fibers (e.g., one or more of those described above) and/or other matrix materials (e.g., one or more of those described above).

The methods of FIG. 4 are not limited to the predictive relationship expressed in Eq. 1 and may include the use of other predictive relationships. For example, in some methods, a predictive relationship can be:

τ=aVI+bVC+cV+dI+eC+f (3),

where a, b, c, d, e, and f are constants that can be selected to minimize differences between interfacial shear strengths between carbon fibers and a polymeric matrix material predicted by Eq. 3 and actual interfacial shear strengths between the polymeric matrix material and the carbon fibers after electrolytic surface treatment of the carbon fibers at corresponding V, I, and C values. To determine actual interfacial shear strengths between the carbon fibers and the polymeric matrix material, the process outlined in the Examples section can be used.

Some embodiments of the present methods for producing a unidirectional carbon fiber tape comprise: passing a first portion of a strand of fibers, the first portion comprising carbon fiber precursor fibers, through one or more ovens to carbonize the first portion, thereby converting carbon fiber precursor fibers of the first portion to carbon fibers, and impregnating carbon fibers of the first portion with matrix material, wherein, as carbon fibers of the first portion are impregnated with matrix material, a second portion of the strand that is upstream of the first portion is passing through the one or more ovens. In some methods, the carbon fiber precursor fibers comprise polyacrylonitrile (PAN) fibers.

In some methods, the matrix material comprises thermoplastic matrix material. In some methods, the thermoplastic matrix material comprises polyethylene terephthalate (PET), polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polysulfone sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof.

In some methods, impregnating carbon fibers of the first portion comprises impregnating carbon fibers of the first portion with molten thermoplastic matrix material. In some methods, impregnating carbon fibers of the first portion with molten thermoplastic matrix material comprises extruding a sheet of thermoplastic matrix material and pressing the sheet and the carbon fibers of the first portion together. In some methods, impregnating carbon fibers of the first portion with molten thermoplastic matrix material comprises passing carbon fibers of the first portion through a bath or a chamber containing molten thermoplastic matrix material.

In some methods, prior to being impregnated, carbon fibers of the first portion are unsized. In some methods, the unsized fibers comprise neither a film former nor a coupling agent and/or are uncoated. In some methods, the width of the first portion of the strand changes by no more than 10%, preferably, by no more than 5%, after passing through the one or more ovens and before being impregnated.

Prior to impregnating carbon fibers of the first portion, the carbon fibers of the first portion can be surface treated at least by those fibers through a bath containing an electrolytic solution and passing a current through the electrolytic solution. In some methods, the current is between 5 and 30 A. In some methods, the current is driven by a voltage that is between 5 and 20 V. In some methods, the electrolytic solution comprises a salt, optionally, ammonium bicarbonate. In some methods, the conductivity of the electrolytic solution is between 5 and 40 mS/cm.

Some embodiments of the present systems for producing a unidirectional carbon fiber tape comprise: heating a portion of a strand of precursor fibers (e.g., in one or more ovens configured to receive and carbonize the portion of the strand of precursor fibers), thereby converting carbon fiber precursor fibers of the portion to carbon fibers, an impregnation unit configured to receive the portion of the strand from the oven and to impregnate carbon fibers of the portion with molten thermoplastic material, and guiding element(s) configured to direct the portion of the strand from the oven(s) and to the impregnation unit. In some systems, the guiding element(s) comprise roller(s), pin(s), and/or plate(s).

In some systems, the impregnation unit comprises a bath or a chamber configured to contain molten thermoplastic matrix material, and the impregnation unit is configured to direct the portion of the strand through the bath or the chamber. In some systems, the impregnation unit comprises an extruder configured to extrude a sheet of molten thermoplastic matrix material and pressing element(s) configured to press the sheet and the portion of the strand together. In some systems, the pressing element(s) comprise roller(s), pin(s), and/or plate(s).

Some embodiments of the present methods for surface treating carbon fibers comprise: selecting an interfacial shear strength for carbon fibers and a polycarbonate matrix material (in other words, choosing an interfacial shear strength based upon the desired adhesion for the intended application of the carbon fibers and polycarbonate matrix material), immersing the carbon fibers in a bath containing an electrolytic solution, the electrolytic solution having a conductivity, and applying a voltage and a current to the electrolytic solution, wherein the value of the applied voltage in V and the value of the applied current in A are within 10% of a voltage value and a current value, respectively, that satisfy the following relationship:

τ=−0.32VI+0.24VC+2.1856V+2.4512I−2.4084C+48.7663,

where τ is the value of the selected interfacial shear strength in N/mm², V is the voltage value, I is the current value, and C is the value of the conductivity in mS/cm. In some methods, the value of the applied voltage and the value of the applied current are within 5% of the voltage value and the current value, respectively.

The selected (e.g., desired) interfacial shear strength can be between 15 and 170 N/mm², optionally, between 30 and 60 N/mm². In some methods, the applied voltage is between 5 and 20 V. In some methods, the applied current is between 5 and 30 A. In some methods, the conductivity is between 5 and 40 mS/cm.

Some embodiments of the present methods for surface treating carbon fibers comprise: immersing carbon fibers in a bath containing an electrolytic solution, the electrolytic solution having a conductivity that is between 5 and 40 mS/cm, and applying a voltage of between 5 and 20 V and a current of between 5 and 30 A to the electrolytic solution such that:

−0.32VI+0.24VC+2.1856V+2.4512I−2.4084C+48.7663>49.1,

where V is the value of the applied voltage in V, I is the value of the applied current in A, and C is the value of the conductivity in mS/cm. In some methods, applying the voltage and the current to the electrolytic solution is such that:

−0.32VI+0.24VC+2.1856V+2.4512I−2.4084C+48.7663>52.0.

In some methods, the applied voltage is between 5 and 15 V. In some methods, the conductivity is between 15 and 35 mS/cm. In some methods, the conductivity is approximately 17.5 mS/cm, optionally, the applied voltage is approximately 8 V, and, optionally, the applied current is approximately 14 A. In some methods, the conductivity is approximately 31.3 mS/cm, optionally, the applied voltage is approximately 12.5 V, and, optionally, the applied current is approximately 26 A. In some methods, the electrolytic solution comprises a salt, and, optionally, the salt comprises ammonium bicarbonate.

In some methods, the carbon fibers comprise PAN-based carbon fibers, which are carbon fibers produced at least by carbonizing fibers that comprise PAN.

Some methods comprise impregnating the carbon fibers with polycarbonate matrix material. In some methods, impregnating the carbon fibers comprises extruding a sheet of the polycarbonate matrix material and pressing the sheet and the carbon fibers together. In some methods, impregnating the carbon fibers comprises passing the carbon fibers through a bath or a chamber containing the polycarbonate matrix material in a molten state. In some methods, prior to being impregnated, the carbon fibers are unsized. In some methods, the unsized fibers comprise neither a film former nor a coupling agent and/or are unsized.

### EXAMPLES

The present invention will be described in greater detail by way of specific examples. The following examples are offered for illustrative purposes only and are not intended to limit the invention in any manner Those of skill in the art will readily recognize a variety of noncritical parameters that can be changed or modified to yield essentially the same results.

### Electrolytically Surface Treated Carbon Fibers and Properties Thereof

As set forth below, carbon fibers were electrolytically surface treated and subsequently tested to determine properties of those fibers.

### A. Production and Electrolytic Surface Treatment of Carbon Fibers

Seven strands of carbon fibers, hereinafter referred to as Samples 1-7, were each produced by carbonizing a strand of polyacrylonitrile fibers. Next, for each of Samples 2-7, fibers of the sample were surface treated by passing the sample through a bath containing an electrolytic solution including ammonium bicarbonate; for comparison purposes, fibers of Sample 1 were not electrolytically surface treated. For each of Samples 2-7, during surface treatment of its fibers, a respective voltage and a respective current were applied to the electrolytic solution, and the electrolytic solution had a respective conductivity, which was set by varying the concentration of ammonium bicarbonate in the electrolytic solution; these parameters are included in Table 1. For each of Samples 2-7, the fibers were passed through the bath at a constant line speed.

TABLE 1
Parameters for Electrolytic Surface Treatment of Samples 2-6

| | Conductivity of | Voltage Applied | Current Applied |
|---|---|---|---|
| | Electrolytic | to Electrolytic | to Electrolytic |
| | Solution | Solution | Solution |
| Sample # | (mS/cm) | (V) | (A) |
| 2 | 17.5 | 5.8 | 8 |
| 3 | 17.5 | 8 | 14 |
| 4 | 17 | 13.5 | 26 |
| 5 | 31.3 | 12.5 | 26 |
| 6 | 31.4 | 8.1 | 14 |
| 7 | 31.2 | 5.7 | 8 |

### B. Mechanical Properties of Electrolytically Surface Treated Carbon Fibers

Twenty-five fibers from each of Samples 1-7 were individually tensile tested using a FAVIMAT+ instrument equipped with a 210 centinewton (cN) load cell. Each test was performed using a 25.0 mm gauge length, a pretension of 0.50 cN per tex, and a test speed of 2.0 mm/min. The results of these tests are provided in Table 2, where, for each of Samples 1-7, each mechanical property is an average of the mechanical property for the 25 fibers tested from the sample.

TABLE 2
Mechanical Properties of Samples 1-7

| | Fiber | Modulus of | Failure | |
|---|---|---|---|---|
| | Diameter | Elasticity | Stress | Elongation at |
| Sample # | (μm) | (GPa) | (GPa) | Failure (%) |
| 1 | 6.54 | 260 | 3.84 | 1.58 |
| 2 | 6.54 | 261 | 3.88 | 1.60 |
| 3 | 6.50 | 266 | 4.05 | 1.63 |
| 4 | 6.55 | 262 | 4.02 | 1.64 |
| 5 | 6.59 | 262 | 4.13 | 1.70 |
| 6 | 6.52 | 263 | 4.38 | 1.79 |
| 7 | 6.56 | 264 | 4.00 | 1.63 |

As shown, fibers that were electrolytically surface treated (those from Samples 2-7) had higher moduli of elasticity and higher failure stresses than fibers that were not electrolytically surface treated (those from Sample 1). Additionally, electrolytically surface treated fibers were more ductile than non-surface treated fibers.

### C. Surface Polarity and Surface Groups of Electrolytically Surface Treated Carbon Fibers

To quantify their surface polarities, individual fibers from each of Samples 1-7 were tested using a KRUSS tensiometer K100SF with water as the test liquid and with 1-bromo-naphthalene as the test liquid. In each test, an advancing contact angle for a single fiber was determined using an immersion depth of 5 mm and a measuring speed of 3 millimeters per minute (mm/min). For each sample, for each test liquid, 10 fibers from the sample were tested, and the advancing contact angles of those fibers were averaged to determine an average advancing contact angle for the sample and the test liquid; these average advancing contact angles are included in Table 3.

TABLE 3
Average Advancing Contact Angle in
each Test Liquid for Samples 1-7

Average Advancing Contact Angle

| Sample # | Water (°) | BrNaph (°) |
|---|---|---|
| 1 | 82.6 | 28.7 |
| 2 | 54.7 | 22.2 |
| 3 | 52.2 | 29.1 |
| 4 | 41.4 | 17.8 |
| 5 | 48.9 | 35.8 |
| 6 | 49.3 | 24.4 |
| 7 | 54.9 | 19.7 |

The average advancing contact angles were converted, using an Owens, Wendt, Rabel, and Kaelble method, to a total surface energy (in millinewtons per meter (mN/m), a polar surface energy, and a dispersive surface energy for the sample. A surface polarity of the sample was determined by taking the ratio—reflected as a percentage—of the polar surface energy to the total surface energy. These values are included in Table 4.

TABLE 4
Surface Energies and Polarities for Samples 1-7

| | Total | Polar | Dispersive | |
|---|---|---|---|---|
| | Surface | Surface | Surface | |
| | Energy | Energy | Energy | Polarity |
| Sample # | (mN/m) | (mN/m) | (mN/m) | (%) |
| 1 | 41.9 | 2.7 | 39.2 | 6.5 |
| 2 | 55.9 | 14.8 | 41.1 | 26.4 |
| 3 | 56.0 | 17.2 | 38.8 | 30.7 |
| 4 | 64.0 | 21.8 | 42.2 | 34.0 |
| 5 | 56.5 | 20.3 | 36.2 | 35.9 |
| 6 | 58.4 | 18.2 | 40.3 | 31.1 |
| 7 | 56.2 | 14.4 | 41.8 | 25.6 |

Surface groups of fibers from each of samples 1-7 were quantified using X-ray photoelectron spectroscopy (XPS). XPS was performed using a KRATOS AXIS ULTRA spectrometer and a mono-A1 Kα1,2 X-ray source operated at 300 watts (W) and 20 milliamps (mA). Pass energy was set to 160 eV (overview), 20 eV. The results are included in Table 5.

TABLE 5
Surface Groups of Samples 1-7

| | Atomic | Atomic | Atomic |
|---|---|---|---|
| | Concentration | Concentration | Concentration |
| Sample # | Hydroxyl (%) | Carboxyl (%) | Nitrile (%) |
| 1 | 1.50 | 1.10 | 2.07 |
| 2 | 1.90 | 1.51 | 4.79 |
| 3 | 2.15 | 1.62 | 4.48 |
| 4 | 3.68 | 2.93 | 5.75 |
| 5 | 3.24 | 3.05 | 7.17 |
| 6 | 3.36 | 2.15 | 6.52 |
| 7 | 3.10 | 1.80 | 6.70 |

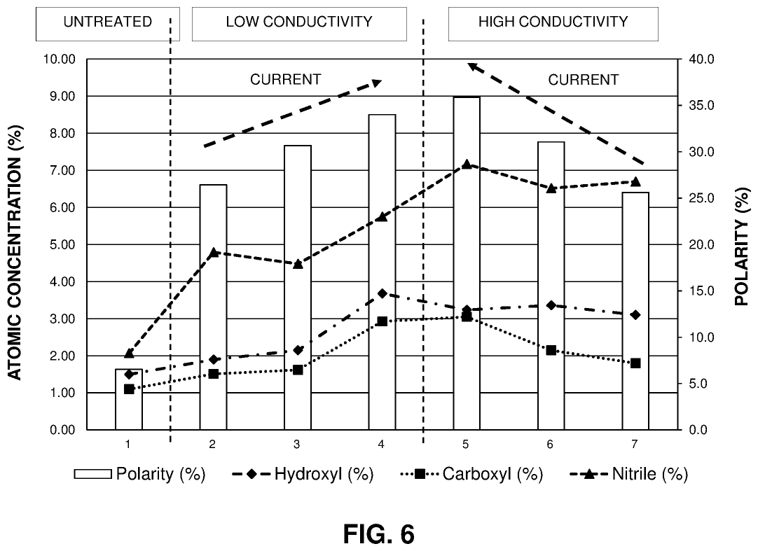

The results of the above are illustrated in FIG. 6. As shown, fibers that were electrolytically surface treated (those from Samples 2-7) had higher surface polarities as well as higher atomic concentrations of hydroxyl, carboxyl, and nitrile surface groups than fibers that were not electrolytically surface treated (those from Sample 1). Amongst fibers that were electrolytically surface treated, those treated at higher currents generally had higher values for these properties than those treated at lower currents.

### D. Interfacial Shear Strengths for Electrolytically Surface Treated Carbon Fibers and a Polycarbonate Matrix Material

Fibers from each of Samples 1-7 were subjected to single-fiber pull-out tests in which individual fibers were embedded in and subsequently pulled from HF1110 polycarbonate matrix material. For each test, 150 μm of a single, unsized fiber was embedded in polycarbonate matrix material by: (1) heating the polycarbonate matrix material in an inert, argon-rich environment to 300° C. at a rate of 15° C./min; (2) holding the polycarbonate matrix material at 300° C. for 30 seconds (s); (3) embedding the fiber in the polycarbonate matrix material; (4) holding the polycarbonate matrix material at 300° C. for 30 s; and (5) cooling the polycarbonate matrix material to room temperature in 30 min. The fiber was subsequently pulled from the polycarbonate matrix material at a speed of 10 nanometers per second (nm/s). Based on the test, an interfacial shear strength between the fiber and the polycarbonate matrix material was determined. For each of Samples 1-7, 15 to 20 fibers were tested and the interfacial shear strengths associated with those fibers were averaged to determine an interfacial shear strength associated with the sample. The results are shown in Table 6.

TABLE 6
Interfacial Shear Strengths between Samples
1-7 and a Polycarbonate Matrix Material

| Sample # | Interfacial Shear Strength (N/mm²) | SEM at EMT of 5.00 kV |
|---|---|---|
| 1 | 48.8 | WD = 7.1 mm |
| 2 | 50.1 | WD = 13 mm |
| 3 | 55.2 | WD = 7.0 mm |
| 4 | 43.2 | WD = 7.3 mm |
| 5 | 54.7 | WD = 13.3 mm |
| 6 | 49.5 | WD = 6.7 mm |
| 7 | 33.3 | WD = 7.0 mm |

EHT electron high tension in kilovolts (kV).
WD stands for working distance in millimeters.

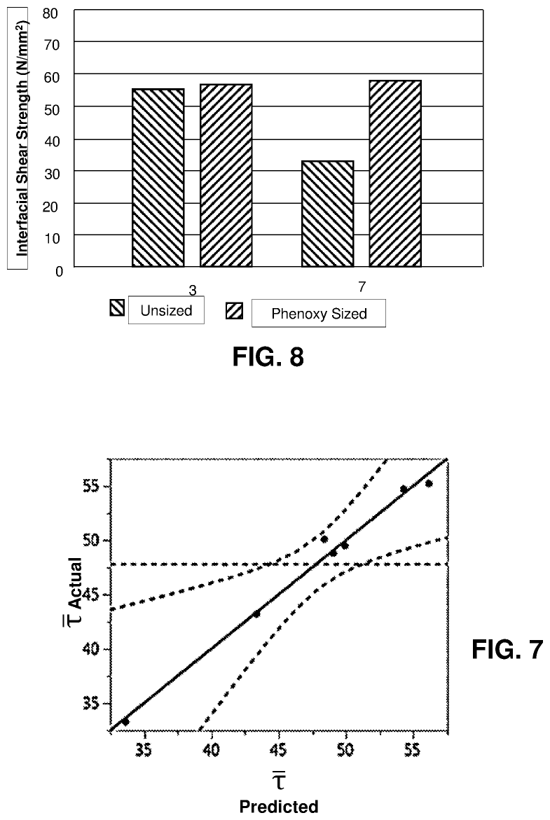

For each of Samples 2-7, an interfacial shear strength between fibers of the sample and a polycarbonate matrix material was predicted with Eq. 1, using the values of the voltage and the current applied to the electrolytic solution during surface treatment of those fibers as V and I, respectively, and the value of the conductivity of the electrolytic solution during surface treatment of those fibers as C. FIG. 7 depicts, for fibers from each of Samples 1-7, actual versus predicted interfacial shear strength. As shown, there was good agreement between the actual and predicted values.

### E. Effect of Sizing on Electrolytically Surface Treated Carbon Fibers

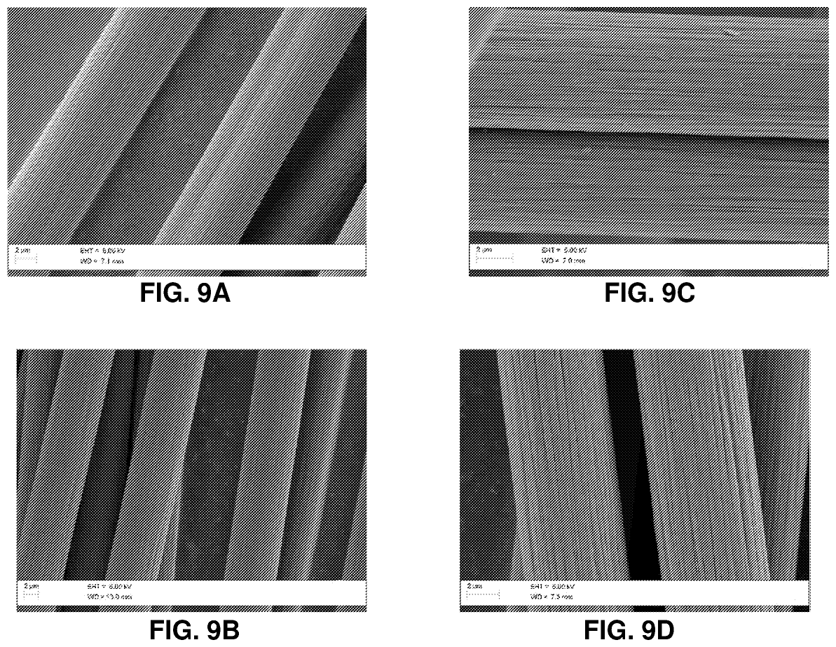

Fibers from each of Samples 3 and 7 were sized with phenoxy sizing material and subsequently subjected to single-fiber pull-out tests as described above; the results of these tests are depicted in FIG. 8. As shown, sizing did not significantly increase the interfacial shear strength associated with fibers from Sample 3, which may indicate that these fibers—due to their electrolytic surface treatment—have a reduced need for sizing. On the other hand, sizing substantially increased the interfacial shear strength associated with fibers from Sample 7, which were electrolytically surface treated using different parameters.

### F. SEM Images of Electrolytically Surface Treated Carbon Fibers

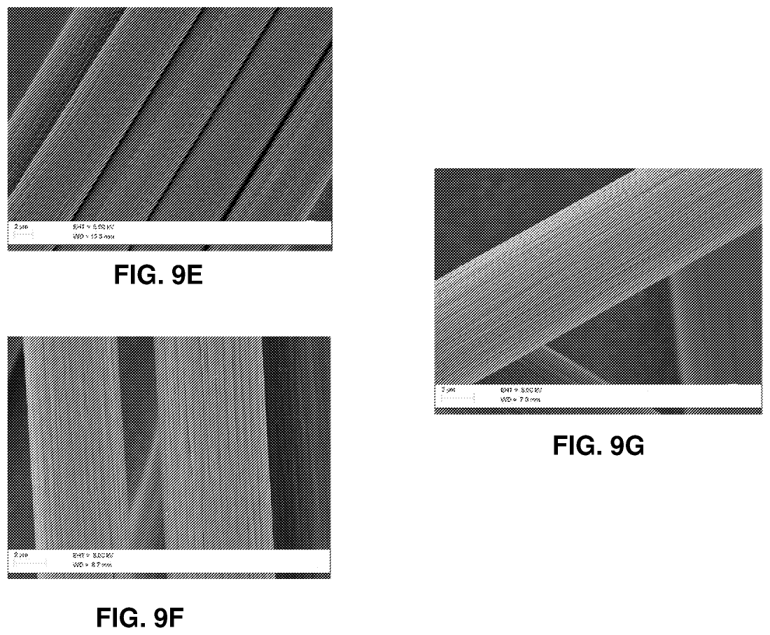

FIGS. 9A-9G are SEM images of fibers from Samples 1-7, respectively. The scale identified on the SEMs is 2 micrometers (μm). As shown, electrolytic surface treatment of fibers, resulting in Samples 2-7, did not appear to significantly damage the fibers.

Set forth below are some aspects of the methods and systems disclosed herein.

Aspect 1: A method for producing a unidirectional carbon fiber tape, the method comprising: passing a first portion of a strand of fibers through an oven to carbonize the first portion, thereby converting precursor fibers of the first portion to carbon fibers, wherein the first portion comprises carbon fiber precursor fibers; and impregnating the carbon fibers of the first portion with thermoplastic matrix material to form impregnated fibers, while a second portion of the strand of fibers that is upstream of the first portion is passing through the oven to convert carbon fiber precursor fibers of the second portion to additional carbon fibers.

Aspect 2: A method for producing a unidirectional carbon fiber tape, the method comprising: heating a first portion of a strand of fibers to convert precursor fibers of the first portion to carbon fibers; and impregnating the carbon fibers of the first portion with thermoplastic matrix material to form impregnated fibers, while a second portion of the strand of fibers that is upstream of the first portion is heated to convert precursor fibers of the second portion to additional carbon fibers.

Aspect 3: The method of any one of Aspects 1-2, wherein the impregnating of the carbon fibers of the first portion comprises impregnating the carbon fibers of the first portion with molten thermoplastic matrix material.

Aspect 4: The method of Aspect 3, wherein: the impregnating of the carbon fibers of the first portion with the molten thermoplastic matrix material comprises: extruding a sheet of thermoplastic matrix material and pressing the sheet and carbon fibers of the first portion together; or passing the carbon fibers of the first portion through molten thermoplastic matrix material.

Aspect 5: The method of any of the preceding aspects, further comprising, prior to the impregnating of the carbon fibers of the first portion, surface treating the carbon fibers of the first portion at least by: passing the carbon fibers of the first portion through an electrolytic solution; and passing a current through the electrolytic solution.

Aspect 6: The method of Aspect 5, wherein the surface treating the carbon fibers of the first portion comprises: immersing the carbon fibers of the first portion in a bath containing the electrolytic solution, wherein the electrolytic solution has a conductivity; and applying a voltage and the current to the electrolytic solution, wherein the value of the applied voltage in volts (v) and the value of the applied current in amps (A) are within 10% (preferably within 5%) of a voltage value and a current value, respectively, that satisfy the following relationship:

τ=−0.32VI+0.24VC+2.1856V+2.4512I−2.4084C+48.7663,

where τ is a desired interfacial shear strength in Newtons per square millimeter (N/mm²), V is the voltage value, I is the current value, and C is the value of the conductivity in millisiemens per centimeter (mS/cm). For example wherein the desired interfacial shear strength for the application for which the carbon fiber tape is intended to be used.

Aspect 7: A method for surface treating carbon fibers, the method comprising: immersing the carbon fibers in a bath containing an electrolytic solution, the electrolytic solution having a conductivity; and applying a voltage and a current to the electrolytic solution, wherein the value of the applied voltage in volts (V) and the value of the applied current in amps (A) are within 10% of a voltage value and a current value, respectively, that satisfy the following relationship:

τ=−0.32VI+0.24VC+2.1856V+2.4512I−2.4084C+48.7663,

where τ is a desired interfacial shear strength in N/mm² for carbon fibers and a matrix material, V is the voltage value, I is the current value, and C is the value of the conductivity in millisiemens per centimeter (mS/cm). For example wherein the desired interfacial shear strength for the application for which the carbon fibers and matrix material (preferably polycarbonate matrix material) are intended to be used.

Aspect 8: The method of Aspect 6, wherein the desired interfacial shear strength is between 15 and 170 N/mm², optionally, the desired interfacial shear strength is between 30 and 60 N/mm².

Aspect 9: The method of any of Aspects 6-7, wherein the applied voltage is between 5 and 20v, preferably between 5 and 15 v.

Aspect 10: The method of any of Aspects 6-8, wherein the applied current is between 5 and 30 A.

Aspect 11: The method of any of Aspects 6-9, wherein the conductivity is between 5 and 40 mS/cm, preferably between 15 and 35 mS/cm.

Aspect 12: The method of any of Aspects 6-10, wherein τ is greater than 49.1, preferably greater than 52.0

Aspect 13: The method of any of Aspects 6-11, wherein the electrolytic solution comprises a salt, and, optionally, the salt comprises ammonium bicarbonate.

Aspect 14: The method of any of the preceding aspects, wherein, prior to being impregnated, carbon fibers of the first portion are unsized.

Aspect 15: The method of Aspect 13, wherein the unsized fibers: comprise neither a film former nor a coupling agent; and/or are uncoated.

Aspect 16: The method of any of the preceding aspects, wherein the first portion of the strand has a width before the oven, and wherein the width of the first portion of the strand changes in the oven by no more than 10%, preferably, by no more than 5%.

Aspect 17: The method of any of the preceding aspects, wherein the carbon fiber precursor fibers comprise polyacrylonitrile (PAN) fibers.

Aspect 18: The method of any of the preceding aspects, wherein the thermoplastic matrix material comprises polyethylene terephthalate, polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polysulfone sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof.

Aspect 19: A system for producing a unidirectional carbon fiber tape, the system comprising: an oven configured to receive and carbonize a portion of a strand of carbon fiber precursor fibers, thereby converting carbon fiber precursor fibers of the portion to carbon fibers; an impregnation unit configured to receive the portion of the strand from the oven and to impregnate carbon fibers of the portion with molten thermoplastic matrix material; and a guiding element configured to direct the portion of the strand from the oven to the impregnation unit.

Aspect 20: The system of Aspect 19, wherein the impregnation unit is configured to contain molten thermoplastic matrix material; and wherein the impregnation unit is configured to direct the portion of the strand through the molten thermoplastic matrix material.

Aspect 21: The system of Aspect 19, wherein the impregnation unit comprises: an extruder configured to extrude a sheet of molten thermoplastic matrix material; and a pressing element configured to press the sheet and the portion of the strand together.

Aspect 22: The system of Aspect 21, wherein the pressing element comprises at least one of a roller, a pin, or a plate.

Aspect 23: The system of any of aspects 19-22, wherein the guiding element comprises at least one of a roller, a pin, or a plate.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/have/include/contain—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

What is claimed is:

1. A method for producing a unidirectional carbon fiber tape, the method comprising:
passing a first portion of a strand of fibers through an oven to carbonize the first portion, thereby converting carbon fiber precursor fibers of the first portion to carbon fibers, wherein the first portion comprises carbon fiber precursor fibers; and
impregnating the carbon fibers of the first portion with thermoplastic matrix material to form impregnated fibers, while a second portion of the strand of fibers that is upstream of the first portion is passing through the oven to convert carbon fiber precursor fibers of the second portion to additional carbon fibers.

2. The method of claim 1, wherein the impregnating of the carbon fibers of the first portion comprises impregnating the carbon fibers of the first portion with molten thermoplastic matrix material.

3. The method of claim 2, wherein: the impregnating of the carbon fibers of the first portion with the molten thermoplastic matrix material comprises:
extruding a sheet of thermoplastic matrix material and pressing the sheet and carbon fibers of the first portion together; or
passing the carbon fibers of the first portion through molten thermoplastic matrix material.

4. The method of any of the preceding claims, wherein the thermoplastic matrix material comprises polyethylene terephthalate, polycarbonats, polybutylene terephthalate, poly(1,4-cyclohexylidene cyclohexane-1,4-dicarboxylate), glycol-modified polycyclohexyl terephthalate, poly(phenylene oxide), polypropylene, polyethylene, polyvinyl chloride, polystyrene, polymethyl methacrylate, polyethyleneimine or polyetherimide or a derivative thereof, a thermoplastic elastomer, a terephthalic acid elastomer, poly(cyclohexanedimethylene terephthalate), polyethylene naphthalate, a polyamide, polysulfone sulfonate, polyether ether ketone, polyether ketone ketone, acrylonitrile butyldiene styrene, polyphenylene sulfide, a copolymer thereof, or a blend thereof.

5. The method of any of the preceding claims, further comprising, prior to the impregnating of the carbon fibers of the first portion, surface treating the carbon fibers of the first portion at least by:
passing the carbon fibers of the first portion through an electrolytic solution; and
passing a current through the electrolytic solution.

6. The method of claim 5, wherein the surface treating the carbon fibers of the first portion comprises
immersing the carbon fibers of the first portion in a bath containing the electrolytic solution, wherein the electrolytic solution has a conductivity; and
applying a voltage and the current to the electrolytic solution, wherein the value of the applied voltage in volts (v) and the value of the applied current in amps (A) are within 10% (preferably within 5%) of a voltage value and a current value, respectively, that satisfy the following relationship:
τ=−0.321VI+0.24VC+2.1856V+2.4512I−2.4084C+48.7663,
where τ is a desired interfacial shear strength in N/mm² for carbon fibers and a polycarbonate matrix material, V is the voltage value, I is the current value, and C is the value of the conductivity in mS/cm.

7. A method for surface treating carbon fibers, the method comprising:
immersing the carbon fibers in a bath containing an electrolytic solution, the electrolytic solution having a conductivity; and
applying a voltage and a current to the electrolytic solution, wherein the value of the applied voltage in volts (V) and the value of the applied current in amps (A) are within 10% of a voltage value and a current value, respectively, that satisfy the following relationship:
τ=−0.32VI+0.24VC+2.1856V+2.4512I−2.4084C+48.7663,
where τ is a desired interfacial shear strength in N/mm² for the carbon fibers and a matrix material, V is the voltage value, I is the current value, and C is the value of the conductivity in mS/cm.

8. The method of claim 6, wherein the desired interfacial shear strength is performed such that the interfacial shear strength is between 15 and 170 N/mm², optionally, the desired interfacial shear strength is between 30 and 60 N/mm².

9. The method of any of claims 6-8, wherein the applied voltage is between 5 and 20v, preferably between 5 and 15 v.

10. The method of any of claims 6-9, wherein the applied current is between 5 and 30 A.

11. The method of any of claims 6-10, wherein the conductivity is between 5 and 40 mS/cm, preferably between 15 and 35 mS/cm.

12. The method of any of claims 6-11, wherein z is greater than 49.1, preferably greater than 52.0.

13. The method of any of claims 6-12, wherein the electrolytic solution comprises a salt, and, optionally, the salt comprises ammonium bicarbonate.

14. The method of any of the preceding claims, wherein, prior to being impregnated, carbon fibers of the first portion are unsized, and preferably wherein the unsized fibers comprise neither a film former nor a coupling agent; and/or are uncoated.

15. The method of any of the preceding claims, wherein the first portion of the strand has a width before the oven, and wherein the width of the first portion of the strand changes in the oven by no more than 10%, preferably, by no more than 5%.

16. The method of any of the preceding claims, wherein the precursor fibers comprise polyacrylonitrile (PAN) fibers.

17. A system for producing a unidirectional carbon fiber tape, the system comprising:
an oven configured to receive and carbonize a portion of a strand of precursor fibers, thereby converting the precursor fibers of the portion to carbon fibers;
an impregnation unit configured to receive the portion of the strand from the oven and to impregnate carbon fibers of the portion with molten thermoplastic matrix material; and
a guiding element configured to direct the portion of the strand from the oven to the impregnation unit.

18. The system of claim 17, wherein
the impregnation unit is configured to contain molten thermoplastic matrix material; and
the impregnation unit is configured to direct the portion of the strand through the molten thermoplastic matrix material.

19. The system of claim 17, wherein the impregnation unit comprises:
an extruder configured to extrude a sheet of molten thermoplastic matrix material; and
a pressing element configured to press the sheet and the portion of the strand together.

20. The system of claim 19, wherein the pressing element and the guiding element, independently, comprises at least one of a roller, a pin, or a plate.
